(19) United States
(12) Patent Application Publication
(10) Pub. No.: US 2005/0068868 A1
(43) Pub. Date: Mar. 31, 2005

(54) Data writing method and data recording apparatus without buffer under-run

(75) Inventor: Shigekatsu Hasegawa, Atsugi-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: MITSUMI ELECTRIC CO., LTD, Tokyo (JP)

(21) Appl. No.: 10/858,669

(22) Filed: Jun. 1, 2004

(30) Foreign Application Priority Data
Sep. 25, 2003 (JP) 332769/2003

(51) Int. Cl. G11B 5/09

(52) U.S. Cl. 369/47.32; 369/53.31; 369/53.2

(57) ABSTRACT

A data recording apparatus (10) has a set of connectors (16) enable to connected to a plurality of types of memory cards. A card reader (12) reads data out of a memory card connected to one of the set of connectors. A CD-R/RW drive (14) writes date read out of the card reader into a CD-R/RW. A CPU (18) of the card reader decides a type of the memory card connected to the connector, determines a writing rate for a CD-R/RW corresponding to a reading rate of the memory card in accordance with the decided type, and sets the determined writing rate in the CD-R/RW drive.

This application claims priority to prior Japanese patent application JP 2003-332769, the disclosure of which is incorporated herein by reference.

### BACKGROUND OF THE INVENTION

This invention relates to a data writing method and a data recoding apparatus for reading data out of a storage media to write read data into an optical disk.

Image data photographed (picked out) by a digital camera is memorized in a memory card (a storage media) as an image file. As well known in the art, the memory cards are detachable recording media using semiconductor memories. The memory cards are classified into various types such as an SD card, a compact flash card, a memory stick, an xD picture card, and a smart medium.

The SD card is a small memory card cooperatively developed by TOSHIBA CORPORATION, Matsushita Electric Industrial Co., Ltd, and SanDisk Corporation. The compact flash card is one of standards of small memory cards and is a small type of a flash memory card of PC card type. The memory stick is one of types of memory cards which are standardized and manufactured by Sony Corporation. The xD picture card is a small flash memory card for a digital camera that is developed by FUJI PHOTO FILM CO., LTD and OLYMPUS CORPORATION. The smart medium is a small memory card having a size of a postage stamp.

Writing the image data stored in such a storage medium (memory card) into an optical disc such as CD-R/RW is usually carried out by using a personal computer (PC). The data recording apparatus according to this invention is an apparatus for writing data stored in various types of memory cards into the optical disc without using the PC.

The data recording apparatus comprises a card reader for reading data out of the memory card and an optical disc drive for writing the data read out of the card reader into the optical disc. The optical disc is, for example, a CD-R/RW drive when the optical disc is a CD-R/RW.

The card reader comprises a buffer memory for temporarily storing data read out of the memory card therein. A random access memory (RAM) is, for example, used as the buffer memory. The buffer memory has a restricted memory capacity (storage capacity). It is therefore impossible to write the data into the optical disc after all of data in the memory card are obtained by the buffer memory. Accordingly, it is necessary to write the data read out of the buffer memory into the optical disc while the data read out of the memory card is written in the buffer memory. That is, it is necessary to write the date into the optical disc while the date is read out of the memory card.

On the other hand, the memory cards have various reading data transfer rate (maximum reading rate) of 0.8-2.5 Megabytes/second and 10 Megabytes/second at products corresponding to high-speed. As a result, if a writing rate for the optical disc is constant, the following problem occurs.

It will be assumed that the writing rate for the optical disc is matched with a low one of reading rates of the memory cards (which is called a first case). Under the circumstances, it will be assumed that a memory card enable to read at a higher rate than that is used. In this event, inasmuch as the reading rate out of the memory card is faster than the writing rate for the optical disc, a reading wait time happens. In other words, it is necessary to temporarily stop the data from reading out of the memory card in order to avoid overflowing the data out of the buffer memory. As a result, the writing rate has a reduced performance.

It will be assumed that the writing rate for the optical disc is matched with a high one of reading rates of the memory cards (which is called a second case). Under the circumstances, it will be assumed that a memory card enable to read at only a lower rate than that is used. In this event, inasmuch as the reading rate out of the memory card is slower than the writing rate for the optical disc, a writing wait time happens. In other words, it is necessary to temporarily stop the date from writing into the optical disc in order to avoid emptying the buffer memory. That is, a phenomenon opposite to the first case happens. Such a phenomenon is called a buffer under-run in the art (see U.S. Pat. No. 6,584,053 issued to Akira Tsukihashi).

The optical disc drives (for example, CD-R/RW drives) for writing data in the optical discs are classified into ones adapted to the buffer under-run and ones unadapted to the buffer under-run. When the optical disc drive unadapted to the buffer under-run is used in the second case, a writing error occurs. Such a writing error is called a buffer under-run error. Even if the optical disc drive adapted to the buffer under-run is used in the second case, performance of the writing rate is degraded if it is frequently used. This is because it takes a time of data link on restarting of writing.

In order to resolve such a problem, Japanese Unexamined Patent Application Publication (JP-A) No. 2003-85876 proposes a data recorder which automatically carries out rewriting by decelerating a writing rate after the optical disc is restored when the buffer under-run error occurs. The JP-A 2003-85876 determines a writing start rate on the basis of the type of the storage medium (the memory card) and storage structure of data in the storage medium.

In the manner which is described above, the above-mentioned prior art documents merely disclose counting methods when the buffer under-run occurs or when the buffer under-run error occurs on the assumption that the buffer under-run inevitably occurs. Although the JP-A 2003-85876 describes that a reference value of the writing start rate is set in accordance with the medium type of the memory card, the reading rate of the memory card is not considered in the JP-A 2003-85876. At any rate, when the buffer under-run (or the buffer under-run error) occurs, the above-mentioned prior art documents are required to cope with this and result in degrading performance of the writing rate.

### SUMMARY OF THE INVENTION

It is therefore an object of the present invention to provide a data writing method and a data recording apparatus which are capable of preventing a buffer under-run from occurring.

It is another object of the present invention to provide a data writing method and a data recording apparatus which are capable of improving performance of a writing rate.

Other objects of this invention will become clear as the description proceeds.

On describing the gist of an aspect of this invention, it is possible to be understood that a data writing method is of reading data out of a storage medium to store read data in a buffer memory as stored data and of writing the stored data into an optical disc. The method comprises the step of making a writing rate for the optical disc change in accordance with a reading rate of the storage medium.

In the above-mentioned data writing method, the writing rate may preferably be selected to a rate near to the reading rate as far as possible. In addition, the writing rate may desirably be a rate so that a buffer under-run of the buffer memory does not occur.

On describing the gist of another aspect of this invention, it is possible to be understood that a data recording apparatus has a set of connectors enable to connected a plurality of types of storage media. The data recording apparatus comprises a data reading arrangement for reading data out of a storage medium connected to a particular one of the set of connectors to store read data in a buffer memory as stored data and a data writing arrangement for writing the stored data into an optical disc. According to this invention, the above-mentioned data recording apparatus further comprises a deciding arrangement for deciding, as a decided type, a type of the storage medium connected to the particular one of the set of connectors, a determining arrangement for determining, as a determined writing rate, a writing rata for the optical disc in accordance with a reading rate of the storage medium on the basis of the decided type, and a setting arrangement for setting the determined writing rate in the data writing arrangement.

In the above-mentioned data recording apparatus, the writing rate may preferably be selected to a rate near to the reading rate as far as possible. In addition, the writing rate may desirably be a rate so that a buffer under-run of the buffer memory does not occur.

### BRIEF DESCRIPTION OF THE DRAWING

FIGS. 1A to 1C collectively show the external appearance of a data recording apparatus according to an embodiment of the present invention;

FIG. 2 is a block diagram of the data recording apparatus illustrated in FIGS. 1A-11C; and

FIG. 3 is a flow chart for use in describing a data writing method according to an embodiment of the present invention.

### DESCRIPTION OF THE PREFERRED EMBODIMENT

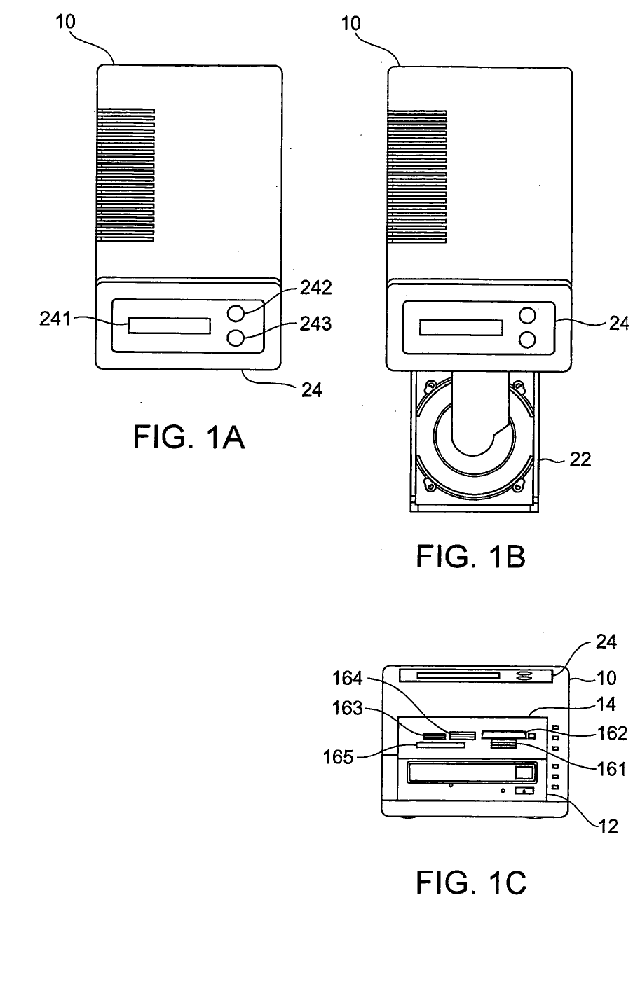

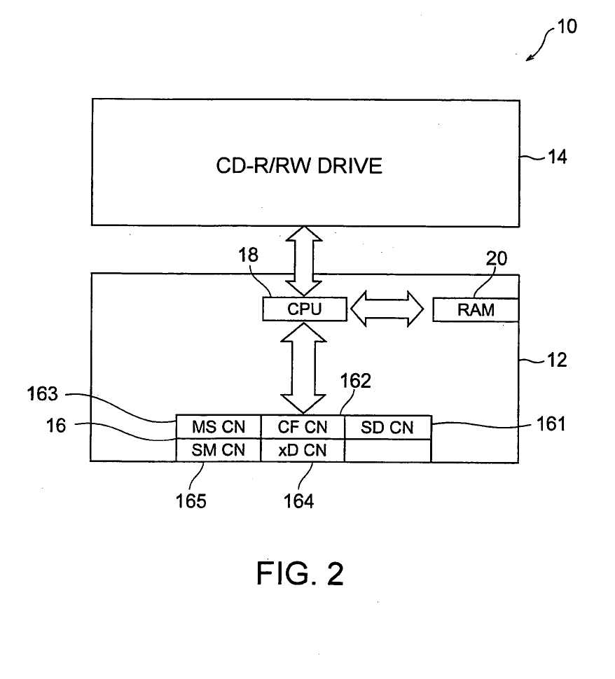

Referring to FIGS. 1A, 1B, 1C, and 2, the description will proceed to a data recording apparatus 10 according to a preferred embodiment of the present invention. FIGS. 1A-1C are views showing the external appearance of the data recording apparatus 10. FIG. 1A is a plan view of the data recording apparatus 10. FIG. 1B is a plan view of the data recording apparatus 10 and shows a state where a tray is opened in front. FIG. 1C is a front view of the data recording apparatus 10. FIG. 2 is a block diagram of the data recording apparatus 10.

As shown in FIG. 2, the data recording apparatus 10 comprises a card reader 12 for reading data out of memory cards (which are described) and a CD-R/RW drive 14 for writing data read out of the card reader 12 into a CD-R/RW.

The card reader 12 and the CD-R/RW drive 14 are disposed in the data recording apparatus 10 up and down as shown in FIG. 1C. In the example being illustrated, the card reader 12 can read five types of memory cards which will presently described. The five types of the memory cards are a SD card, a compact flash (CF) card, a memory stick (MS), a xD picture card, and a smart medium (SM). In order to read the five types of memory cards, the card reader 12 comprises a SD card connector (SDCN) 161, a compact flash card connector (CFCN) 162, a memory stick connector (MSCN) 163, an xD picture card connector (xDCN) 164, and a smart medium connector (SMCN) 165.

The card connector 12 comprises a central processing unit (CPU) 18 connected to their five connectors 161-165 through an interface. The CPU 18 is connected to a random access memory (RAM) 20 acting as a buffer memory.

The CPU 18 is connected to the CD-R/RW drive 14 through ATAPI (Advanced Technology Attachment Packet Interface). The CPU 18 performs all of processing such as reading of data from the memory card, writing of data into the CD-R/RW, and so on. The RAM 20 stores data read out of the memory card and data for performing a program.

The CD-R/RW drive 14 has a tray depicted at 20 for mounting the CD-R/RW (not shown) thereon.

The data recording apparatus 10 comprises an operation panel 24 at an upper front. The operation panel 24 has a liquid crystal display (LCD) 241, a YES button 242, and a NO button 243.

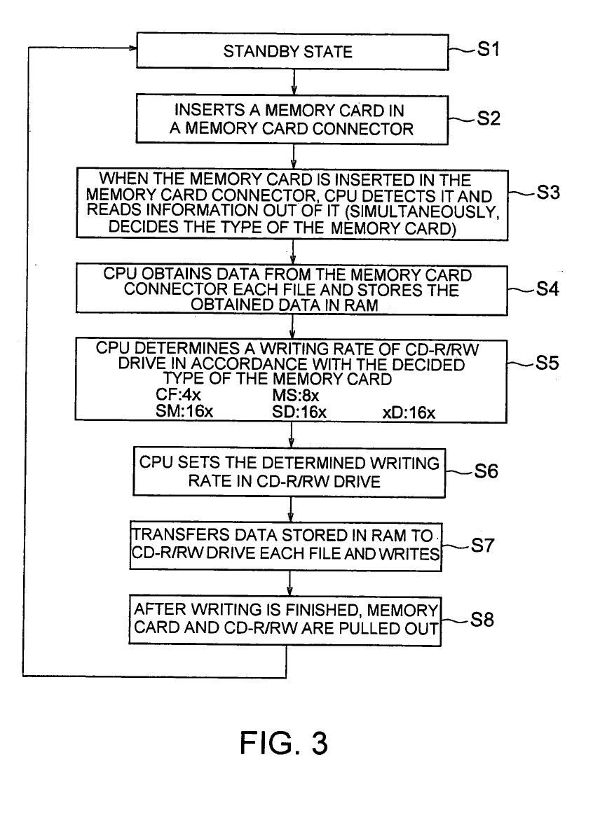

Referring now to FIG. 3 in addition to FIGS. 1A-1C and 2, the description will proceed to a data writing method of the data recording apparatus 10 according to the present invention.

First, the data recording apparatus 10 is put into a standby state (step S1). In this state, a user inserts a memory card in the memory card connector 16 (step S2). That is, any one of the SD card, the compact flash card, the memory stick, the xD picture card, and the smart medium is inserted in one of the SD card connector 161, the compact flash card connector 162, the memory stick connector 163, the xD picture card connector 164, and the smart medium connector 165.

When the memory card is inserted in the memory card connector 16 (when the memory card is connected to the memory card connector 16), the CPU 18 detects it and reads information out of it (step S3). Simultaneously, the CPU decides, a decided type, the type of the memory card (step S3).

The CPU 18 obtains data from the memory card connector 16 each file and stores the obtained data in the RAM 20 (step S4). The CPU 18 determines a writing rate of the CD-R/RW in the CD-R/RW drive 14 in accordance with the decided type (a reading rate) of the memory card (step S5).

For example, the writing rate for the CD-R/RW is one time rate (1×) of 176.5 kilobytes/second. It will be assumed that the inserted memory card is the compact flash card. In this event, inasmuch as the reading rate of the compact flash card is 700 kilobytes/second, the CPU 18 determines that the writing rate for the CD-R/RW drive is four times rate (4×) of 706 kilobytes/sec. It will be assumed that the inserted memory card is the SD card having a capacity of 128 megabytes or less. In this event, inasmuch as the SD card has a maximum transfer rate (reading rate) of 2 megabytes/second, the CPU 18 determines that the writing rate of the CD-R/RW Is sixteen times rate (16×) of 2.76 megabytes/second. Similar determination is carried out in other memory cards. When the inserted memory card is the memory stick, the CPU 18 determines that the writing rate of the CD-R/RW is eight times rate (8×) of 1.38 megabytes/second. When the inserted memory card is the xD picture card, the CPU 18 determines that the writing rate of the CD-R/RW is sixteen times rate (16×) of 2.76 megabytes/second. When the inserted memory card is the smart medium, the CPU 18 determines that the wiring rate of the CD-R/RW is sixteen times rate (16×) of 2.76 megabytes/second.

The CPU 18 sets the determined writing rate in the CD-R/RW drive 14 (step S6). In the manner which is described above, the CPU 18 sets (changes) the writing rate for the CD-R/RW in accordance with the reading rate of the inserted memory card. In this event, in the manner which is described above, the writing rate for the CD-R/RW is selected to a rate near to the reading rate of the inserted (connected) memory card as far as possible. As a result, the writing rate for the CD-R/RW is set to a rate where the buffer under-run does not occur.

The CPU 18 transfers the data stored in the RAM 20 to the CD-R/RW drive 14 each file and the CD-R/RW drive 14 writes the transferred data into the CD-R/RW (step S7).

After writing is finished, the user pulls the memory card and the CD-R/RW out the data recording apparatus 10 (step S8).

The data is read from the memory card to the RAM 20 while the read data is written to the CD-R/RW. Accordingly, the RAM 20 is always put into a state where the data is stored therein in the meanwhile. Although the writing rate for the CD-R/RW is set to the rate near to the reading rate of the memory card as far as possible in this invention, their rates are not always consistent with each other.

It will be assumed that the writing rate and the reading rate are set to substantially matched rate. In this event, it is preferable to start the writing of data for the CD-R/RW at a time when data is stored in the RAM 20 with an amount corresponding to a half of its storage capacity. It will be assumed that the writing rate is faster than the reading rate. In this event, it is preferable to start the writing of data for the CD-R/RW at a time when data is stored in the RAM 20 with a fill of its storage capacity as far as possible. It will be assumed that the writing rate is slower than the reading rate. In this event, it is preferable to start the writing of data for the CD-R/RW at a time when data is stored in the RAM 20 with a little. By setting a start point of the data writing in the manner which is described above, it is possible to prevent the buffer under-run (writing wait time) or reading wait time from occurring.

Inasmuch as the writing rate for the CD-R/RW (the optical disc) is automatically set in accordance with the reading rate of the inserted memory card (storage medium), it is possible to keep loss of writing time for the optical disc to a minimum and to improve performance of the writing rate without occurring the buffer under-run.

While this invention has thus far been described in conjunction with a preferred embodiment thereof, it will now be readily possible for those skilled in the art to put this invention into various other manners.

1. A method of reading data out of a storage medium to store read data in a buffer memory as stored data and of writing said stored data into an optical disc, said method comprising the step of making a writing rate for said optical disc change in accordance with a reading rate of said storage medium.

2. The method as claimed in claim 1, wherein said writing rate is selected to a rate near to said reading rate as far as possible.

3. The method as claimed in claim 1, wherein said writing rate is a rate so that a buffer under-run of said buffer memory does not occur.

4. The method as claimed in claim 2, wherein said writing rate is a rate so that a buffer under-run of said buffer memory does not occur.

5. A data recording apparatus having a set of connectors enable to connected a plurality of types of storage media, said data recording apparatus comprising:
data reading means for reading data out of a storage medium connected to a particular one of said set of connectors to store read data in a buffer memory as stored data;
data writing means for writing said stored data into an optical disc;
deciding means for deciding, as a decided type, a type of said storage medium connected to the particular one of said set of connectors;
determining, as a determined writing rate, a writing rata for said optical disc in accordance with a reading rate of said storage medium on the basis of the decided type; and
setting the determined writing rate in said data writing means.

6. The data recording apparatus as claimed in claim 5, wherein said writing rate is selected to a rate near to said reading rate as far as possible.

7. The data recording apparatus as claimed in claim 5, wherein said writing rate is a rate so that a buffer under-run of said buffer memory does not occur.

8. The data recording apparatus as claimed in claim 6, wherein said writing rate is a rate so that a buffer under-run of said buffer memory does not occur.
